(19) United States
(12) Patent Application Publication
(10) Pub. No.: US 2026/0269866 A1
(43) Pub. Date: Sep. 10, 2026

(54) APPROACHES FOR SIMULTANEOUS TRANSMISSION FROM MULTIPLE ANTENNA PANEL ENTITIES

(71) Applicant: Telefonaktiebolaget LM Ericsson (publ), Stockholm (SE)

(72) Inventors: Andreas NILSSON, Göteborg (SE); Shiwei GAO, Nepean (CA); Siva MURUGANATHAN, Stittsville (CA)

(73) Assignee: Telefonaktiebolaget LM Ericsson (publ), Stockholm (SE)

(21) Appl. No.: 19/167,721

(22) PCT Filed: Mar. 21, 2023
(86) PCT No.: PCT/EP2023/057170

§ 371 Date: Sep. 22, 2025

(51) Int. Cl. H04B 7/022; H04B 7/0404; H04B 7/06; H04B 7/08; H04L 5/00; H04W 24/10

(52) U.S. Cl. CPC H04B 7/022; H04B 7/0404; H04B 7/063; H04B 7/06956; H04B 7/0874; H04L 5/0048; H04W 24/10

(57) ABSTRACT

A method is disclosed for a wireless communication device configured for communication with a wireless communication network and having a plurality of antenna panel entities. The method comprises performing measurements for first and second groups of reference signal resources, wherein each group of reference signal resources is associated with reference signal transmission from a respective radio access node of the wireless communication network, and transmitting first and second measurement reports.

Each measurement uses a respective antenna panel entity with a respective spatial filter setting, and the method also comprises indicating, to the wireless communication network, combinations of reference signal resources indicated by the first and second measurement reports that correspond to combinations of antenna panel entities which are configurable for simultaneous transmission from the wireless communication device.

### TECHNICAL FIELD

The present disclosure relates generally to the field of wireless communication. More particularly, it relates to simultaneous transmission from multiple antenna panel entities.

### BACKGROUND

A wireless communication network may employ a plurality radio access nodes for communication with a wireless communication device operating in association with the wireless communication network.

In some situations, two or more radio access nodes may simultaneously transmit to the wireless communication device, or simultaneously receive from the wireless communication device. An example of simultaneous transmission to, or reception from, the wireless communication device is the application of multiple transmission/reception points (so-called multi-TRP).

Communication between a wireless communication device and radio access nodes of a wireless communication network is typically performed based on beam reporting from the wireless communication device, wherein the wireless communication device indicates one or more suitable beam(s) for communication with a radio access node.

A problem in these situations is that the wireless communication device might not be able to handle simultaneous communication (transmission or reception) on beams reported as suitable for two or more radio access nodes. For example, when the wireless communication device comprises two antenna panels, one beam reported as suitable for one radio access node may be associated with one of the antenna panels, while another beam reported as suitable for another radio access node may be associated with the other one of the antenna panels. If the two antenna panels are not configured for simultaneous operation, communication on the two beams cannot be handled simultaneously.

Therefore, there is a need for approaches that enable management of simultaneous communication with two or more radio access points for a wireless communication device with more than one antenna panel.

### SUMMARY

It should be emphasized that the term “comprises/comprising” (replaceable by “includes/including”) when used in this specification is taken to specify the presence of stated features, integers, steps, or components, but does not preclude the presence or addition of one or more other features, integers, steps, components, or groups thereof. As used herein, the singular forms “a”, “an” and “the” are intended to include the plural forms as well, unless the context clearly indicates otherwise.

Generally, when an arrangement is referred to herein, it is to be understood as a physical product; e.g., an apparatus. The physical product may comprise one or more parts, such as controlling circuitry in the form of one or more controllers, one or more processors, or the like.

It is an object of some embodiments to solve or mitigate, alleviate, or eliminate at least some of the above or other disadvantages.

A first aspect is a method for a wireless communication device configured for communication with a wireless communication network and having a plurality of antenna panel entities.

The method comprises performing measurements for first and second groups of reference signal resources, wherein each group of reference signal resources is associated with reference signal transmission from a respective—first and second—radio access node of the wireless communication network, and wherein each measurement uses a respective antenna panel entity with a respective spatial filter setting.

The method also comprises transmitting first and second measurement reports, wherein each measurement report indicates one or more reference signal resource(s) from a corresponding one of the first and second groups of reference signal resources, and indicating (to the wireless communication network) combinations of reference signal resources indicated by the first and second measurement reports that correspond to combinations of antenna panel entities which are configurable for simultaneous transmission from the wireless communication device.

In some embodiments, each antenna panel entity of the plurality of antenna panel entities comprises one or more of: a physical antenna panel, a virtual antenna panel, and a logical antenna panel.

In some embodiments, the method further comprises transmitting a capability message to the wireless communication network, wherein the capability message indicates a capability of the wireless communication device to indicate antenna panel entity configurability for simultaneous transmission in association with measurement reporting comprising at least two measurements reports.

In some embodiments, the capability message comprises information regarding which combinations of antenna panel entities among the plurality of antenna panel entities are configurable for simultaneous transmission from the wireless communication device.

In some embodiments, each measurement report further identifies a corresponding antenna panel entity for each indicated reference signaling resource.

In some embodiments, the method further comprises receiving a report setting from the wireless communication network, wherein the report setting indicates a respective-first and second-setting for each of the first and second measurement reports, wherein the first setting indicates the first group of reference signal resources and the second setting indicates the second group of reference signal resources.

It should be noted that the first and second report settings may be comprised in a single report setting message, or (typically) the first and second report settings may be comprised in respective, separate, report setting messages.

Generally, the first and second report settings are associated with each other (e.g., by being comprised in a single report message, or by an explicit or implicit association between separate report setting messages) to let the wireless communication device know that the first and second report settings are linked to each other. For example, separate report setting messages may be associated with each other via an RRC configured parameter in the report settings.

In some embodiments, the report setting further indicates (for each reference signal resource of a group of reference signal resources) the spatial filter setting to be used for performing corresponding measurement.

In some embodiments, the report setting further indicates that all antenna panel entities used to perform measurements for the first group of reference signal resources are to be configurable for simultaneous transmission from the wireless communication device with all antenna panel entities used to perform measurements for the second group of reference signal resources.

In some embodiments, at least one of the first and second measurement reports comprises (for each reference signal resource of a group of reference signal resources) identification of reference signal resources for simultaneous transmission among reference signal resources indicated by the other-first or second-measurement report.

In some embodiments, at least one of the first and second measurement reports comprises information that any reference signal resource indicated by the first measurement report is for simultaneous transmission with any reference signal resources indicated by the second measurement report.

In some embodiments, the method further comprises receiving a configuration message from the wireless communication network, wherein the configuration message configures the wireless communication device to indicate antenna panel entity configurability for simultaneous transmission in association with measurement reporting comprising at least two measurements reports.

In some embodiments, the method further comprises receiving a trigger message from the wireless communication network, wherein reception of the trigger message causes measurements to be performed for at least one of the first and second groups of reference signal resources.

In some embodiments, the method further comprises receiving an activation message from the wireless communication network, wherein reception of the activation message causes measurements to be repeatedly performed for the first and second groups of reference signal resources.

In some embodiments, the method further comprises determining whether a measurement condition is met, wherein determination that the measurement condition is met causes measurements to be performed for at least one of the first and second groups of reference signal resources.

In some embodiments, each measurement report indicates a performance metric for each indicted reference signal resource, wherein the performance metric is specific for the antenna panel entity corresponding to the indicted reference signal resource.

In some embodiments, the performance metric for an antenna panel entity is based on maximum exposure constraints of the antenna panel entity.

A second aspect is a method for a wireless communication network configured for communication with a wireless communication device having a plurality of antenna panel entities.

The method comprises causing the wireless communication device to perform measurements for first and second groups of reference signal resources, wherein each group of reference signal resources is associated with reference signal transmission from a respective-first and second-radio access node of the wireless communication network, and wherein each measurement uses a respective antenna panel entity with a respective spatial filter setting.

The method also comprises receiving first and second measurement reports, wherein each measurement report indicates one or more reference signal resource(s) from a corresponding one of the first and second groups of reference signal resources, and acquiring (from the wireless communication device) information regarding combinations of reference signal resources indicated by the first and second measurement reports that correspond to combinations of antenna panel entities which are configurable for simultaneous transmission from the wireless communication device.

In some embodiments, the method further comprises receiving a capability message from the wireless communication device, wherein the capability message indicates a capability of the wireless communication device to indicate antenna panel entity configurability for simultaneous transmission in association with measurement reporting comprising at least two measurements reports.

In some embodiments, causing the wireless communication device to perform measurements comprises transmitting a report setting to the wireless communication device, wherein the report setting indicates a respective—first and second—setting for each of the first and second measurement reports, wherein the first setting indicates the first group of reference signal resources and the second setting indicates the second group of reference signal resources.

In some embodiments, causing the wireless communication device to perform measurements comprises transmitting a configuration message to the wireless communication device, wherein the configuration message is for configuring the wireless communication device to indicate antenna panel entity configurability for simultaneous transmission in association with measurement reporting comprising at least two measurements reports.

In some embodiments, causing the wireless communication device to perform measurements comprises transmitting a trigger message to the wireless communication device, wherein the trigger message is for causing measurements to be performed for at least one of the first and second groups of reference signal resources.

In some embodiments, causing the wireless communication device to perform measurements comprises transmitting an activation message to the wireless communication device, wherein the activation message is for causing measurements to be repeatedly performed for the first and second groups of reference signal resources.

In some embodiments, the method further comprises performing scheduling of simultaneous transmission from the wireless communication device based on the first and second measurement reports, and on the acquired information regarding combinations of reference signal resources.

A third aspect is a computer program product comprising a non-transitory computer readable medium, having thereon a computer program comprising program instructions. The computer program is loadable into a data processing unit and configured to cause execution of the method according to any of the first and second aspects when the computer program is run by the data processing unit.

A fourth aspect is an apparatus for a wireless communication device configured for communication with a wireless communication network and having a plurality of antenna panel entities.

The apparatus comprises controlling circuitry, which is configured to cause performance of measurements for first and second groups of reference signal resources, wherein each group of reference signal resources is associated with reference signal transmission from a respective-first and second-radio access node of the wireless communication network, and wherein each measurement uses a respective antenna panel entity with a respective spatial filter setting.

The controlling circuitry is also configured to cause transmission of first and second measurement reports, wherein each measurement report indicates one or more reference signal resource(s) from a corresponding one of the first and second groups of reference signal resources, and indication (to the wireless communication network) of combinations of reference signal resources indicated by the first and second measurement reports that correspond to combinations of antenna panel entities which are configurable for simultaneous transmission from the wireless communication device.

A fifth aspect is a wireless communication device comprising the apparatus of the fourth aspect.

A sixth aspect is an apparatus for a wireless communication network configured for communication with a wireless communication device having a plurality of antenna panel entities.

The apparatus comprises controlling circuitry, which is configured to cause the wireless communication device to perform measurements for first and second groups of reference signal resources, wherein each group of reference signal resources is associated with reference signal transmission from a respective-first and second-radio access node of the wireless communication network, and wherein each measurement uses a respective antenna panel entity with a respective spatial filter setting.

The controlling circuitry is also configured to cause reception of first and second measurement reports, wherein each measurement report indicates one or more reference signal resource(s) from a corresponding one of the first and second groups of reference signal resources, and acquisition (from the wireless communication device) of information regarding combinations of reference signal resources indicated by the first and second measurement reports that correspond to combinations of antenna panel entities which are configurable for simultaneous transmission from the wireless communication device.

A seventh aspect is a radio access node comprising the apparatus of the sixth aspect.

An eighth aspect is a central processing node comprising the apparatus of the sixth aspect.

In some embodiments, any of the above aspects may additionally have features identical with or corresponding to any of the various features as explained above for any of the other aspects.

An advantage of some embodiments is that approaches are provided that enable management of simultaneous communication with two or more radio access points for a wireless communication device with more than one antenna panel.

An advantage of some embodiments is that they enable a wireless communication network to determine whether radio access node beams, which are reported as preferred by a multi-panel wireless communication device (e.g., during a beam management procedure based on downlink reference signaling), can be used for simultaneous uplink transmission.

An advantage of some embodiments is that performance may be improved-compared to at least some other approaches-in at least some scenarios (e.g., multi-TRP, D-MIMO, and similar) that involve communication between a wireless communication device and two or more radio access nodes. The performance may be improved in terms of any suitable metric; e.g., uplink throughput.

### BRIEF DESCRIPTION OF THE DRAWINGS

Further objects, features and advantages will appear from the following detailed description of embodiments, with reference being made to the accompanying drawings. The drawings are not necessarily to scale, emphasis instead being placed upon illustrating the example embodiments.

FIG. 1 is a collection of schematic drawings illustrating example signaling between a transmission/reception point (TRP) and a user equipment (UE) according to some embodiments;

FIG. 2 is a schematic drawing illustrating an example wireless communication device having a plurality of antenna panel entities according to some embodiments;

FIG. 3 is a flowchart illustrating example method steps according to some embodiments;

FIG. 4 is a flowchart illustrating example method steps according to some embodiments;

FIG. 5 is a signaling diagram illustrating example signaling according to some embodiments;

FIG. 6 is a schematic drawing illustrating example signaling between two TRPs and a UE according to some embodiments;

FIG. 7 is a schematic block diagram illustrating an example apparatus according to some embodiments;

FIG. 8 is a schematic block diagram illustrating an example apparatus according to some embodiments;

FIG. 9 is a schematic drawing illustrating an example communication system according to some embodiments; and

FIG. 10 is a schematic drawing illustrating an example computer readable medium according to some embodiments.

### DETAILED DESCRIPTION

As already mentioned above, it should be emphasized that the term “comprises/comprising” (replaceable by “includes/including”) when used in this specification is taken to specify the presence of stated features, integers, steps, or components, but does not preclude the presence or addition of one or more other features, integers, steps, components, or groups thereof. As used herein, the singular forms “a”, “an” and “the” are intended to include the plural forms as well, unless the context clearly indicates otherwise.

Embodiments of the present disclosure will be described and exemplified more fully hereinafter with reference to the accompanying drawings. The solutions disclosed herein can, however, be realized in many different forms and should not be construed as being limited to the embodiments set forth herein.

In the following, approaches will be described and exemplified for management of simultaneous communication with two or more radio access points for a wireless communication device with more than one antenna panel. Throughout this description, transmission/reception points (TRPs) will be used to exemplify radio access nodes, and a user equipment (UE) will be used to exemplify a wireless communication device. However, it should be noted that embodiments may be equally applicable for other types of radio access nodes and other types of wireless communication devices.

Furthermore, it should be noted that, even if the exemplification herein often refers to two (first and second) feature instantiations (e.g., radio access nodes, groups of reference signal resources, measurement reports, etc.), the suggested approaches are not limited thereto. Contrarily, embodiments are equally applicable for situations with more than two radio access nodes, groups of reference signal resources, measurement reports, etc.

Some embodiments may be suitable for communication in accordance with the Third Generation Partnership Project (3GPP) standardization of the fifth generation (5G; particularly 5G advanced) and/or of the sixth generation (6G).

For NR up to Rel-17, UL transmission has mainly been considered for a UE with single antenna panel transmission (i.e., at each moment in time, transmission from at most a single UE antenna panel). For NR-Rel-18, PUSCH transmission with up to two simultaneously transmitting UE panels is considered (a.k.a., simultaneous multi-panel transmission, STxMP) for association with different TRPs.

According to some embodiments, the wireless communications device performs measurements for first and second groups of reference signal resources. Each group of reference signal resources is associated with reference signal transmission from a respective (first and second) radio access node of the wireless communication network, and each measurement uses a respective antenna panel entity of the wireless communications device; with a respective spatial filter setting. The wireless communications device transmits first and second measurement reports, wherein each measurement report indicates one or more reference signal resource(s) from a corresponding one of the first and second groups of reference signal resources.

In the description herein, the terminology includes “spatial filter setting”, “spatial filtering configuration”, “spatial filtering weights”, “beams”, and similar expressions. Such terminology is intended to broadly refer to the same concept; namely reception and/or transmission of a communication node (e.g., a TRP or a UE) that is non-uniform over the directional dimension. Generally, an antenna panel entity may be associated with one or more possible spatial filter setting. For example, a spatial filter setting may refer to antenna weights that are applied at a communication node for transmission and/or reception. Typically, the spatial filter setting aims for matching the propagation channel environment. It should be noted that, even though a spatial filter setting may not always correspond strictly to a beam, the above terminology is used interchangeably. Thus, the occurrences of “spatial filter setting”, “spatial filtering configuration”, “spatial filtering weights”, and similar expressions may typically be exemplified by “beam”, and the occurrences of “beam” and similar expressions may typically be broadened to “spatial filter setting”, “spatial filtering configuration”, “spatial filtering weights”, etc.

To enable the wireless communication network to properly schedule simultaneous transmission from the wireless communications device to the first and second radio access node, the wireless communications device indicates (to the wireless communication network) combinations of reference signal resources indicated by the first and second measurement reports that correspond to combinations of antenna panel entities which are configurable for simultaneous transmission from the wireless communication device.

At least some embodiments are particularly beneficial when TRPs operate independently from each other (e.g., due to slow backhaul) and in relation to the wireless communication device, such that group-based beam reporting is not applicable.

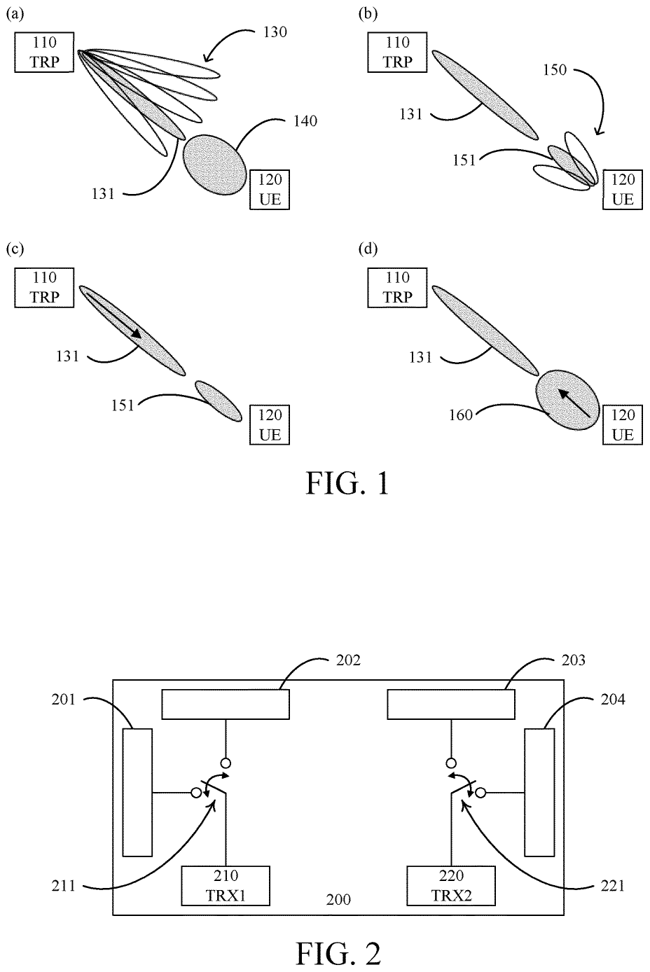

FIG. 1 schematically illustrates example signaling between a transmission/reception point (TRP) 110 and a user equipment (UE) 120 according to some embodiments. The example signaling exemplifies beam selection and subsequent communication between the TRP 110 and the UE 120.

Part (a) of FIG. 1 shows the TRP 110 transmitting downlink (DL) reference signaling using a plurality of (relatively narrow) beams 130, which may be utilized by the UE 120 to identify a preferred beam 131 of the plurality of beams 130. The identification by the UE 120 typically comprises using a (relatively wide) beam 140 for reception, and determining the preferred beam 131 as the one with best reception performance (e.g., highest received signal strength) among the plurality of beams 130. The UE 120 reports an indication of the identified preferred beam 131 to the TRP 110, and the TRP 110 performs beam selection based on the report.

Part (b) of FIG. 1 shows the TRP 110 repeatedly transmitting downlink (DL) reference signaling using a particular (relatively narrow) beam 131 (typically a beam identified as preferred by the UE 120), which may be utilized by the UE 120 to identify a suitable beam 151 among a plurality of (relatively narrow) beams 150. Thereby, the beam 151 with best reception performance (e.g., highest received signal strength) among the plurality of beams 150 may be identified and selected by the UE 120.

Part (c) of FIG. 1 shows DL communication, where the TRP 110 uses the selected beam 131 for DL transmission and the UE 120 uses the corresponding selected beam 151 for DL reception.

Part (d) of FIG. 1 shows UL communication, where the UE 120 uses a (relatively wide) beam 160 for UL transmission and the TRP 110 uses the selected beam 131 for UL reception.

The approaches according to some embodiments may, for example, be applicable in relation to the example signaling illustrated in FIG. 1. For example, the DL reference signaling of part (a) of FIG. 1 may be performed by two or more TRPs 110 for multi-TRP operation, and the UE 120 may provide corresponding two or more reports indicating preferred beams 131 and indicate combinations of the reported preferred beams 131 that correspond to combinations of UE antenna panels which are configurable for simultaneous transmission from the UE 120.

FIG. 1 may be used as an illustration of beam management (e.g., according to 3GPP standardization). For example, approaches for handling mobility between beams (both within and between TRPs) at mmW frequencies have been specified in 3GPP for the concept of New Radio (NR). At such frequencies, high-gain beamforming is typically used. Consequently, each beam is typically optimal only within a relatively small area, and the link budget typically deteriorates quickly outside the optimal beam area. Hence, frequent and fast beam switching may be needed to maintain high performance.

To support beam switching, a beam indication framework has been specified in NR. For example, for downlink (DL) data transmission (e.g., in physical downlink shared channel, PDSCH), the downlink control information (DCI) comprises a transmission configuration indicator (TCI) field that informs the UE regarding which beam is used for the DL transmission, and the UE can adjust its reception beam accordingly. This is particularly beneficial for analog reception (RX) beamforming, where the UE needs to determine and apply the RX beamforming weights before it receives the PDSCH. Part (c) of FIG. 1 may be seen as illustrating PDSCH signaling in NR.

Prior to data transmission (e.g., PDSCH), a training phase is typically required in order to determine the spatial filtering configurations for the TRP and UE. In NR, this procedure is referred to as DL beam management. Parts (a) and (b) in FIG. 1 may be seen as illustrating DL beam management in NR.

In NR, two types of reference signals (RSs) are used for DL beam management; channel state information RS (CSI-RS) and synchronization signal/physical broadcast control channel (SS/PBCH) block (synchronization signal block, SSB, for short). Parts (a) and (b) in FIG. 1 may be seen as illustrating an example where reference signalling is used to find an appropriate beam pair link (BPL); i.e., a suitable TRP transmit spatial filtering configuration 131 and a suitable corresponding UE reception spatial filtering configuration 151, which together result in sufficiently good link budget.

In part (a) of FIG. 1, the TRP 110 may be seen as performing a gNB transmission (TX) beam sweep, in relation to which the TRP 110 configures the UE 120 to perform measurements on a group of, for example, five reference signal resources RS1-RS5 (e.g., CSI-RS resources). Transmission in the five reference signal resources applies five different spatial filtering configurations (e.g., five different TX beams, as illustrated by 130).

For example, the UE 120 may be configured to report reference signal identity (RS ID) and reference signal received power (RSRP) of the reference signal resource that corresponds to the maximum measured RSRP. Thereby, the TRP 110 acquires information regarding which gNB TX beam is preferred by the UE 120. In the example of part (a) of FIG. 1, the maximum measured RSRP corresponds to RS4, as illustrated by 131.

In part (b) of FIG. 1, the UE 120 may be seen as performing a subsequent UE reception (RX) beam sweep. For the UE RX beam sweep, the TRP 110 applies the same spatial filtering configuration for transmission in, for example, three reference signal resources RS6-RS8, wherein the spatial filtering configuration corresponds to the gNB TX beam 131 that was reported as preferred by the UE 120.

The UE 120 uses the three reference signal resources, in which the same spatial filtering configuration for transmission is applied, to perform measurements for different RX spatial filtering configurations (e.g., RX beams), as illustrated by 150. The UE 120 notes the spatial filtering configuration (represented by 151) that results in the largest RSRP and relates it to the RS ID that corresponds to the used TX filtering configuration (represented by 131).

When DL data to the UE 120 is subsequently scheduled (compare with part (c) of FIG. 1), the network can refer to the RS ID (e.g., in the TCI that is carried in a field in the DCI that schedules PDSCH) to enable the UE 120 to select the appropriate RX spatial filtering configuration for PDSCH reception. For example, the TRP 110 may indicate to the UE 120 that the PDSCH demodulation reference signal (DMRS) is spatially quasi-co-located with the RS on which the UE performed measurements during the UE beam sweep in the beam training phase (compare with part (b) of FIG. 1). A similar approach is possible for downlink control transmission using physical downlink control channel (PDCCH).

Similarly, when UL transmission from the UE 120 is subsequently scheduled (compare with part (d) of FIG. 1), the network can refer to the RS ID to indicate to the UE 120 which RX spatial filtering configuration the TRP 110 will use for physical uplink control channel (PUCCH) and/or physical uplink shared channel (PUSCH).

A PDSCH may be transmitted to a UE from multiple TRPs. Since different TRPs may have different physical locations and different beams, the propagation channels can be different. To facilitate receiving PDSCH data from different TRPs and/or different beams, a UE may be configured (e.g., by radio resource control, RRC) with multiple spatial filtering configurations (e.g., via multiple TCI states).

For example, a TCI state may comprise quasi-co-location (QCL) information specifying a relation between the DMRS for a PDSCH and one or two DL reference signals (e.g., non-zero-power, NZP, CSI-RS or SSB), where different DL reference signals may be associated with different TRPs and/or different beams. The QCL information can be used by the UE to apply channel properties associated with the DL reference signals to the DMRS of PDSCH for channel estimation and PDSCH reception.

For PDSCH, a subset of the configured TCI states may be activated by medium access control control element (MAC-CE). One or two of the activated TCI states may be dynamically selected (depending on which TRP(s) and/or beam(s) are used for the PDSCH), and the selected TCI state(s) may be indicated in the DCI which schedules PDSCH.

Typically, each codepoint of the TCI field in DCI can indicate either 1 TCI state or two TCI states. A TCI field codepoint indicating 1 TCI state can be used to transmit PDSCH from a single TRP and/or single beam. A TCI field codepoint indicating 2 TCI states can be used to transmit PDSCH from two TRPs and/or two beams.

FIG. 2 schematically illustrates an example wireless communication device 200 having a plurality of antenna panel entities according to some embodiments.

Generally, an antenna panel entity may be any collection of antenna elements that are configured to cooperate to provide spatial filtering. For example, the collection of antenna elements may be comprised on the same physical antenna panel, or may include antenna elements from two or more different physical antenna panel. Alternatively or additionally, all antenna elements of a physical antenna panel may belong to the same collection of antenna elements, or different antenna elements of a physical antenna panel may be part of two or more different collections. Thus, an antenna panel entity may be a physical antenna panel, a virtual antenna panel, a logical antenna panel, or similar.

In FIG. 2, the plurality of antenna panel entities are illustrated as a plurality of physical antenna panels 201, 202, 203, 204.

The wireless communication device 200 also comprises first and second transceiver entities (TRX1, TRX2) 210, 220, each comprising one or more respective transceiver chain(s), wherein a transceiver chain generally comprises a transmitter chain and/or a receiver chain. The first transceiver entity 210 is operatively connectable to the antenna panels 201 and 202 via a first switching functionality 211, and the second transceiver entity 220 is operatively connectable to the antenna panels 203 and 204 via a second switching functionality 221.

It should be noted that each antenna panel typically has one transceiver chain per polarization (i.e., each transceiver entity 210, 220 typically comprises two transceiver chains; one per polarization). The sharing of transceiver entity among two or more antenna panels typically entails that some combinations of antenna panels cannot be used simultaneously. For example, it might not be possible to use the antenna panels 201 and 202 for simultaneous transmission (e.g., when the first switching functionality 211 is configured to operatively connect only one of the antenna panels 201 and 202 at a time to a transmitter chain of the first transceiver entity 210). Similarly, it might not be possible to use the antenna panels 203 and 204 for simultaneous transmission (e.g., when the second switching functionality 221 is configured to operatively connect only one of the antenna panels 203 and 204 at a time to a transmitter chain of the second transceiver entity 220). Thus, it might be so that only the antenna panel combinations [201 and 203], [201 and 204], [202 and 203], and [202 and 204] are possible to use for simultaneous transmission from the wireless communication device 200, while any antenna panel combinations comprising [201 and 202] or [203 and 204] are not possible to use for simultaneous transmission.

The approaches according to some embodiments may, for example, be applicable in relation to the wireless communication device 200 illustrated in FIG. 2. The wireless communication device 200 may, for example, perform measurements on DL reference signaling from two or more TRPs for multi-TRP operation, provide corresponding two or more reports indicating preferred beams, and indicate combinations of the reported preferred beams that correspond to combinations of antenna panels which are configurable for simultaneous transmission.

For example, two preferred beams may be identified for a first TRP by reception via the antenna panels 201 and 204, respectively, and one preferred beam may be identified for a second TRP by reception via the antenna panel 203. Then, in addition to reporting indications of the preferred beams to the TRPs, the wireless communication device 200 may be configured to indicate that simultaneous UL transmission for multi-TRP operation is possible by combining the preferred beams—for the first and second TRPs-that correspond to reception via antenna panels 201 and 203 (and/or that simultaneous UL transmission for multi-TRP operation is not possible by combining the preferred beams that correspond to reception via antenna panels 204 and 203).

To handle UE panels with different capabilities, UE panel specific capabilities may be included in beam reports. For example, the UE may report a list of UE capability value sets during UE capability signaling, where each UE capability value set comprises information about maximum number of supported SRS ports for different UE panels. Each UE capability value may be associated with a different capability (i.e., a different number of supported SRS ports). Each UE panel is then associated with a UE capability value set.

For example, a UE may have four UE panels (P1, P2, P3, P4), where each of P1, P2, P3 has two TX chains (i.e., can support a maximum of two SRS ports) and P4 has only a single TX chain (i.e., can support only a single SRS port). Then, the UE would report-in its capability signaling-two UE capability value sets (one that indicates a maximum of two supported SRS ports and one that indicates a maximum of one supported SRS port). For each beam indicated in a beam report, the UE could that include an index of a UE capability value set to indicate how many SRS ports are supported by the UE panel that was used to receive the RS associated with the indicated beam.

It should be noted that, when the term “UE capability value set” is used herein, it is meant to encompass any set indication with the same, or similar, function as the UE capability value set currently specified by 3GPP, even if not formally termed as a UE capability value set.

As already mentioned, there is a need for approaches that enable management of simultaneous communication with two or more radio access points for a wireless communication device with more than one antenna panel.

One problem with simultaneous multi-panel UL transmission is that the network can typically not know which UE panels can be used for simultaneous transmission. For example, in the current NR specification, the network can configure the UE with group-based beam reporting. According to group-based beam reporting, the UE should report a pair of beams that can be simultaneously received by the UE. However, the network cannot deduce from group-based beam reporting whether the reported beam pair is received with different UE panels, and—if so—whether the UE is able to simultaneously transmit from the two UE panels.

In multi-TRP operation, two or more TRPs might operate independently of each other (e.g., due to slow backhaul), but in relation to the same UE. According to the prior art, a TRP of such a multi-TRP scenario can determine neither whether a beam indicated in a report from the UE can be used for simultaneous DL reception with a beam indicated in relation to another TRP, nor whether a beam indicated in a report from the UE can be used for simultaneous UL transmission with a beam indicated in relation to another TRP.

According to some embodiments, these problems are addressed by introducing non-group-based beam reporting for simultaneous multi-panel UL transmission to two or more TRPs.

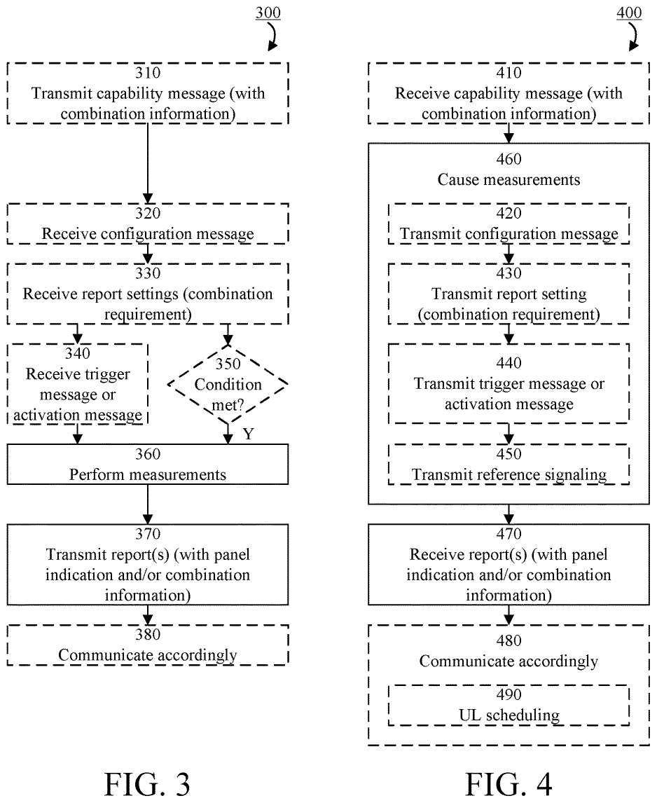

FIG. 3 illustrates an example method 300 for a wireless communication device, wherein the wireless communication device is configured for communication with a wireless communication network and has a plurality of antenna panel entities. For example, the wireless communication device may be exemplified by the wireless communication device 200 of FIG. 2 and/or the UE 120 of FIG. 1.

FIG. 4 illustrates an example method 400 for a wireless communication network, wherein the wireless communication network is configured for communication with a wireless communication device that has a plurality of antenna panel entities. For example, the wireless communication network may be exemplified by a network comprising the TRP 110 of FIG. 1. In relation to FIG. 4, it should be noted that the method 400 may be performed by a TRP of the wireless communication network (e.g., by each of a first TRP and a second TRP), or by a central processing node configured to control operation of the wireless communication network (e.g., a network control node, a cloud server node, or similar). In some embodiments, some steps of the method 400 are performed by TRP(s) and some steps of the method 400 are performed by a central processing node.

FIG. 3 and FIG. 4 will now be described together to illustrate example interaction between a wireless communication device performing the method 300 and a wireless communication network performing the method 400.

As illustrated by step 360, the wireless communication device performs measurements for two or more groups of reference signal resources. The measurements may be performed by application of any suitable measurement approach.

Each group of reference signal resources is associated with reference signal transmission (compare with 130 of FIG. 1) from a respective radio access node of the wireless communication network, as illustrated by step 450 (which is shown as optional to encompass the scenario when the method 400 is performed by a central processing node). Furthermore, each measurement uses a respective antenna panel entity (compare with 201, 202, 203, 204 of FIG. 2) with a respective spatial filter setting (compare with 140, 150 of FIG. 1).

As illustrated by step 460, the wireless communication network causes the wireless communication device to perform the measurements of step 360. The causing may be implemented in any suitable way, a few examples of which are described later herein. In some embodiments, the reference signal transmission may be an implementation of causing the wireless communication device to perform the measurements of step 360. This is illustrated in FIG. 4 in that optional step 450 is a sub-step to step 460.

As illustrated by steps 370 and 470, the wireless communication device transmits a measurement report for each group of reference signal resources when the measurements of step 360 have been performed, and the measurement reports are received by the wireless communication network. For example, a first measurement report may be received by/via (at least) a first radio access node and a second measurement report may be received by/via (at least) a second radio access node. Thus, each measurement report may be for a corresponding one of the (e.g., first and second) transmission nodes.

The first report may be transmitted via a first PUSCH (e.g., dynamically scheduled PUSCH) targeted to the first radio access node, and the second report may be transmitted via a second PUSCH (e.g., dynamically scheduled PUSCH or configured grant PUSCH) targeted to the first and/or second radio access node.

Each measurement report indicates (e.g., via indices) one or more reference signal resource(s) from a corresponding one of the groups of reference signal resources. An indicated reference signal resource typically corresponds to the reference signal resource which was used by a radio access node to transmit reference signaling on a preferred beam (compare with 131 of FIG. 1). Thus, spatial filtering for the radio access node which is preferred by the wireless communication device may be inferred by the indicated reference signal resource(s).

Typically, the measurement reports are associated with each other such that the wireless communication network can identify them as relating to simultaneous communication between the wireless communication device and the radio access nodes. The association may be implemented in any suitable way, as exemplified later herein.

In some embodiments, the transmission of the measurement reports is implemented as non-group-based reporting.

The wireless communication device also indicates combinations of reference signal resources indicated by the measurement reports that correspond to combinations of antenna panel entities which are configurable for simultaneous transmission from the wireless communication device, and the information regarding the combinations is acquired by the wireless communication network. The indication of the combinations and the acquisition of the corresponding information may be implemented in any suitable way, a few examples of which are described later herein.

The simultaneous transmission from the wireless communication device refers to simultaneous (typically independent) transmission to the radio access nodes.

Generally, an indicated combination comprises at least one reference signal resource indicated by a first measurement report and at least one reference signal resource indicated by a second measurement report.

Also generally, that an indicated combination of reference signal resources corresponds to a combination of antenna panel entities means that the wireless communication device used a first antenna panel entity of the combination of antenna panel entities when measurements were performed for a first reference signal resource of the combination of reference signal resources, and used a second antenna panel entity of the combination of antenna panel entities when measurements were performed for a second reference signal resource of the combination of reference signal resources.

The indication of combinations may, for example, imply that all combinations of one reference signal resource indicated by a first measurement report with one reference signal resource indicated by a second measurement report can be used for simultaneous transmission from the wireless communication device. Such an indication may be implemented in a relatively compact manner (e.g., using a single bit).

Alternatively or additionally, the indication of combinations may imply that no combination of a reference signal resource indicated by a first measurement report and a reference signal resource indicated by a second measurement report is guaranteed to be suitable for simultaneous transmission from the wireless communication device. Such an indication may be implemented in a relatively compact manner (e.g., using a single bit).

Yet alternatively or additionally, the indication of combinations may imply which combinations of a reference signal resource indicated by a first measurement report and a reference signal resource indicated by a second measurement report can be used for simultaneous transmission from the wireless communication device.

The indication of combinations may be implemented using the concept of UE capability value sets (or some similar logical index associated with antenna panel entities). For example, the measurements reports may indicate the UE capability value set for each indicated reference signal resource, or the configuration message may indicate that different UE capability value sets should be used for measurements relating to different radio access nodes (i.e., different UE capability value sets should be used for measurements relating to the first and second groups of reference signal resources).

Typically, each report indicates the UE capability value set used to preform measurements for the first group of reference signal resources as well as the UE capability value set used to preform measurements for the second group of reference signal resources (i.e., both reports may indicate the respective UE capability set for both groups of reference signal resources). Generally, when it is mentioned herein that a combination of indicated reference signal resources can be used for simultaneous transmission from the wireless communication device, it means that the wireless communication device may perform simultaneous UL transmission to the radio access nodes that performed reference signal transmission in the indicated reference signal resources. Typically, the spatial filter settings (e.g., beams) used for reference signal transmission in the reference signal resources are suitable for reception of the UL transmissions.

In some embodiments, the combinations of indicated reference signal resources that correspond to combinations of antenna panel entities which are configurable for simultaneous transmission from the wireless communication device are explicitly indicated via one, or both/all, of the reports of steps 370 and 470. For example, a measurement report may comprise, for each indicated reference signal resource, identification of the reference signal resources (as indicated by the other measurement report) that can be used for simultaneous transmission. Alternatively or additionally, a measurement report may comprise information that any reference signal resource indicated by the measurement report can be used for simultaneous transmission together with any reference signal resources indicated by the other measurement report.

As illustrated by optional steps 310 and 410, the methods 300 and 400 may commence by the wireless communication device transmitting a capability message, which is received by the wireless communication network. The capability message indicates a capability of the wireless communication device to indicate antenna panel entity configurability for simultaneous transmission in association with measurement reporting comprising at least two measurements reports. Thus, the capability message may be used to inform the wireless communication network that the wireless communication device is capable of reporting reference signal resource indications while indicating combinations that can be used for simultaneous transmission from the wireless communication device. For example, the capability message may indicate that the wireless communication device supports non-group-based beam reporting for simultaneous multi-panel UL transmission.

The configuration message may be conveyed in any suitable way. For example, the configuration message may be conveyed by RRC signaling.

For example, the capability message may be transmitted in association with connection to the wireless communication network by the wireless communication device. Thereafter, relevant information of the capability message may be conveyed within the wireless communication network as the wireless communication device is handed over between radio access nodes. Alternatively or additionally, the capability message may be transmitted in association with a handover of the wireless communication device between radio access nodes.

According to some embodiments, the capability message may comprise information regarding which combinations of antenna panel entities among the plurality of antenna panel entities are configurable for simultaneous transmission from the wireless communication device. For example, the capability message may comprise a list of antenna panel entities (or the UE capability value sets) of the wireless communication device. Each antenna panel entity (or each UE capability value set) may be associated with an indication of which other antenna panel entity/-ies (or UE capability value set(s)) can be used for simultaneous transmission from the wireless communication device together with that antenna panel entity (or UE capability value set).

In some of these embodiments, each measurement report may identify—for each indicated reference signaling resource-a corresponding antenna panel entity (e.g., the antenna panel entity that was used to perform measurements for the indicated reference signaling resource). Thereby, the report may be used together with the capability message by the wireless communication network to determine combinations of reference signal resources indicated by the measurement reports that correspond to combinations of antenna panel entities which are configurable for simultaneous transmission from the wireless communication device.

The information of the capability message (regarding which combinations of antenna panel entities are configurable for simultaneous transmission) and the identification in the reports (regarding a corresponding antenna panel entity for each indicated reference signaling resource) may be explicit or implicit.

For example, the information of the capability message may comprise a list of set identifiers (e.g. indices), wherein each set identifier corresponds to a set (e.g., a UE capability set) of antenna panel entities that can be used for simultaneous UL transmission. Then, the identification in the reports (regarding a corresponding antenna panel entity for each indicated reference signaling resource) may comprise the set identifier for the set that the corresponding antenna panel entity belongs to. Thereby, the wireless communication network can safely use a combination of reference signal resources indicated by the measurement reports for simultaneous transmission from the wireless communication device when the indicated reference signal resources are associated with a same set identifier. Correspondingly, the wireless communication network cannot safely use a combination of reference signal resources indicated by the measurement reports for simultaneous transmission from the wireless communication device when the indicated reference signal resources are associated with different set identifiers. Thus, the combinations of indicated reference signal resources that correspond to combinations of antenna panel entities which are configurable for simultaneous transmission from the wireless communication device may be seen as indicated via a combination of the capability message of steps 310 and 410 and the reports of steps 370 and 470.

Alternatively or additionally, the capability message may comprise information regarding the number of antenna panel entities of the wireless communication device, and/or information regarding which combinations of antenna panel entities among the plurality of antenna panel entities are configurable for simultaneous reception by the wireless communication device.

In some embodiments, the capability message may—additionally or alternatively-indicate a number of ports per antenna panel.

In some embodiments, the capability message may—additionally or alternatively-indicate antenna panel identifiers (e.g., indices), and one or more of the above information may be associate with corresponding antenna panel identifier in the capability message.

Thus, according to some embodiments, a UE may indicate to the network (during UE capability signaling) that it supports non-group-based beam reporting for simultaneous multi-panel UL transmission. The capability message may also indicate one or more of: the number of UE panels (or the number of UE capability value sets) for the UE, which UE panels (or UE capability value sets) can be used for simultaneous UL transmissions, and which UE panels (or UE capability value sets) can be used for simultaneous DL reception.

As illustrated by optional steps 320 and 420, the wireless communication network may transmit a configuration message, which is received by the wireless communication device. The configuration message configures the wireless communication device to indicate antenna panel entity configurability for simultaneous transmission in association with measurement reporting comprising at least two measurements reports (e.g., by indicating that the wireless communication device should perform non-group-based beam reporting for STxMP).

The configuration message may be conveyed in any suitable way. For example, the configuration message may be conveyed by RRC signaling and/or MAC-CE signaling.

In some embodiments, the configuration message may be a message that comprises a field for DL reference signal configuration, specifying first and second groups of reference signal resources.

For example, the wireless communication network may transmit the configuration message in response to one or more of: receiving the capability message in step 410, switching to multi-TRP (or similar) operation, and determining a need for simultaneous UL transmission to two or more radio access nodes.

In some embodiments, the transmission of the configuration message may be an implementation of causing the wireless communication device to perform the measurements of step 360. This is illustrated in FIG. 4 in that optional step 420 is a sub-step to step 460.

As illustrated by optional steps 330 and 430, the wireless communication network may transmit a report setting, which is received by the wireless communication device. The report setting may be comprised in the configuration message of steps 320 and 420, or may be conveyed as a message separate from the configuration message.

In some embodiments, the transmission of the report setting may be an implementation of causing the wireless communication device to perform the measurements of step 360. This is illustrated in FIG. 4 in that optional step 430 is a sub-step to step 460.

The report setting indicates a respective setting (including a respective group of reference signal resources) for each of the measurement reports. Thus, the report setting provides information specifying which reference signal resources should be used for the measurements of step 360.

In some embodiments, the report setting may also indicate (for each reference signal resource of a group of reference signal resources) the spatial filter setting to be used for performing corresponding measurement.

In some embodiments, the report setting may—alternatively or additionally-indicate that all antenna panel entities used to perform measurements for a first group of reference signal resources are to be configurable for simultaneous transmission from the wireless communication device with all antenna panel entities used to perform measurements for a second group of reference signal resources. Thus, the combinations of indicated reference signal resources that correspond to combinations of antenna panel entities which are configurable for simultaneous transmission from the wireless communication device may be seen as indicated via a combination of the report setting of steps 320 and 430 and the reports of steps 370 and 470.

In some embodiments, the report setting may—alternatively or additionally-indicate an association between the reports such that the wireless communication network can identify them as relating to simultaneous communication between the wireless communication device and the radio access nodes. The association indication may be implicit or explicit. For example, the report setting may configure a field in each of the reports, which indicates a link between the reports.

In some embodiments, the report setting may—alternatively or additionally-indicate when, and/or how often, the reference signal resources occur.

In some embodiments, the report setting may—alternatively or additionally-indicate when, and/or how often, the reports should be transmitted.

Generally, the report setting may comprise any suitable information relating to the content of the reports and/or the transmission of the reports. Some example information of a report setting (e.g., a CSI report configuration) includes:
Resources for channel measurement: e.g., an identifier (ID) pointing to a CSI-ResourceConfig containing either NZP CSI-RS resource sets or SSB resource sets.
Resources for interference measurement: e.g., an optional ID pointing to a CSI-ResourceConfig containing CSI-IM (CSI interference measurement) resource sets or NZP CSI-RS resource sets.
Report configuration type: e.g., periodic, semi-persistent, or aperiodic.
Reporting quantity: defining what the report should include, e.g., none (nothing to report), CRI-RI-PMI-CQI, CRI-RI-i1, CRI-RI-i1-CQI, CRI-RI-CQI, CRI-RSRP, SSB-index-RSRP, CRI-RI-LI-PMI-CQI, wherein CRI denotes CSI-RS resource indicator, RI denotes rank indicator, PMI denotes precoder matrix indicator, CQI denotes channel quality indicator, RSRP denotes reference signal received power, LI denotes layer indicator, and SSB denotes synchronization signal block.
Frequency configuration: e.g., wideband, sub-band, subset of sub-band.
Time domain measurement restriction.
Codebook configuration information.
Information regarding which channel quality indicator (CQI) table to use.

The report setting may be conveyed by radio resource control (RRC) according to some embodiments.

In some embodiments, a field (e.g., “nonGroupBasedBeamReporting-STxMP”) is defined for report setting (e.g., a new field for CSI-ReportConfig IE as specified in 3GPP technical specification TS 38.331); e.g., as follows:

ASN1START
-- TAG-CSI-REPORTCONGIG-START

| | |
|---|---|
| CSI-ReportConfig ::= | SEQUENCE { |
| reportConfigId | CSI-ReportConfigId, |

[[

| | |
|---|---|
| nonGroupBasedBeamReporting-STxMP | ENUMERATED {Enable} |

]]
}
-- TAG-CSI-REPORTCONGIG-STOP
ASN1STOP

When the corresponding parameter is set to “Enable”, the UE should use the report setting for non-group-based beam reporting, and the report setting should be linked with one or more other report settings that have the parameter set to “Enable”. This is an example of association between first and second report settings to let the wireless communication device know that the first and second report settings are linked to each other.

According to some embodiments, the UE should-when configured accordingly, e.g., with the above parameter field set to “Enable” in two report settings-use a first set of spatial filters when receiving the reference signals associated with the first report (or report setting), and a second set of spatial filters when receiving the reference signals associated with the second report (or report setting), where the first set of spatial filters are associated with a first set of UE panel entities and the second set of spatial filters are associated with a second set of UE panel entities, and where the first and second set of UE panel entities are disjunct. Provided that all UE panel entities can be used for simultaneous UL transmission together with any/all other UE panel entities, this approach guarantees that any combination of reported reference signal resources correspond to a combination of UE panel entities that can be used for simultaneous UL transmission.

According to some embodiments, the UE should-when configured accordingly, e.g., with the above parameter field set to “Enable” in two report settings-use a first set of spatial filters when receiving the reference signals associated with the first report (or report setting), and a second set of spatial filters when receiving the reference signals associated with the second report (or report setting), where the first set of spatial filters are associated with a first set of UE panel entities and the second set of spatial filters are associated with a second set of UE panel entities, where the first and second set of UE panel entities are disjunct, and where the UE can perform simultaneous UL transmission from any combination of a UE panel entity of the first set and a UE panel entity of the second set.

According to some embodiments, the UE should-when configured accordingly, e.g., with the above parameter field set to “Enable” in two report settings-include in each report (i.e., both the first report associated with the first report setting and the second report associated with the second report setting) an indication of a first set of UE panel entities and an indication of a second set of UE panel entities, where the first set of UE panel entities corresponds to the set of UE panel entities that are associated with a first set of spatial filters used when receiving the reference signals associated with the first first report (or report setting), and where the second set of UE panel entities corresponds to the set of UE panel entities that are associated with a second set of spatial filters used when receiving the reference signals associated with the second report (or report setting). For example, if the network knows (e.g. from UE capability signalling) which UE panel entities can be used for simultaneous UL transmission, a TRP can determine if it can safely schedule the UE with UL transmission for an indicated TRP beam.

As illustrated by optional steps 340 and 440, the wireless communication network may transmit a trigger message or an activation message, which is received by the wireless communication device. The trigger/activation message may be conveyed together with the report setting of steps 330 and 430 (either as an explicit message or implicitly inferred by the report setting transmission), or may be conveyed together with the configuration message of steps 320 and 420 (either as an explicit message or implicitly inferred by the configuration message transmission), or may be conveyed as a message separate from the configuration message and the report setting.

The trigger/activation message may be conveyed in any suitable way. For example, the trigger/activation message may be conveyed by DCI and/or MAC-CE. A first DCI transmitted from a first TRP may trigger a first report setting and a second DCI transmitted from a second TRP may trigger a second report setting, or a first DCI transmitted from a first TRP may trigger a first report setting and a second report setting.

In some embodiments, the transmission of the trigger/activation message may be an implementation of causing the wireless communication device to perform the measurements of step 360. This is illustrated in FIG. 4 in that optional step 440 is a sub-step to step 460.

The activation message may be configured to cause measurements to be repeatedly (e.g., periodically) performed for the groups of reference signal resources.

The trigger message may be configured to cause measurements to be performed a limited number of times (e.g., once). Thus, repeated performance of measurements may require repeatedly transmitted trigger messages.

The trigger message may be configured to cause measurements to be performed for at least one of the groups of reference signal resources. For example, a trigger message may cause measurements to be performed for a group of reference signal resources corresponding to the radio access node that transmitted the trigger message, as well as for a group of reference signal resources corresponding to another radio access node. Alternatively, a trigger message may cause measurements to be performed only for a group of reference signal resources corresponding to the radio access node that transmitted the trigger message (i.e., each radio access node may need to transmit a respective trigger message for causing measurements to be performed for their corresponding group of reference signal resources).

For example, the trigger message may be transmitted in response to a performance evaluation of the wireless communication network, which indicates that currently used spatial filter settings at the radio access nodes are sub-optimal.

In some embodiments, the wireless communication device may be configured to autonomously determine to perform measurements for the groups of reference signal resources. The possibility for autonomous determination to perform measurements may be combined with the possibility to transmit trigger/activation messages from the wireless communication network, or may be implemented without the possibility to transmit trigger/activation messages from the wireless communication network.

The possibility for autonomous determination to perform measurements is illustrated by optional step 350, wherein it is determined whether a measurement condition is met. When the measurement condition is met (Y-path out of step 350), the method 300 proceeds to step 360 where measurements are performed (once, or repeatedly) for at least one of the first and second groups of reference signal resources. When the measurement condition is not met (not shown), the method 300 lingers until the condition is met, or another disruptive event occurs (e.g., reception of a trigger message or that a time for repeated measurements is reached).

For example, the measurement condition may be based on a performance evaluation of the wireless communication device, and the measurement condition may be considered to be met when the performance evaluation indicates that currently used spatial filter settings at the radio access nodes are sub-optimal.

Alternatively or additionally, the measurement condition may be considered to be met when a beam (or a spatial filter) corresponding to one of the radio access nodes changes.

In some embodiments, each measurement report indicates a performance metric (e.g., based on maximum exposure constraints) for each indicted reference signal resource, wherein the performance metric is specific for the antenna panel entity corresponding to the indicted reference signal resource.

For example, the maximum exposure constraints may relate to the concept of maximum permissible exposure (MPE). In 3GPP, two methods have been introduced to enable the UE to comply with regulatory exposure limits: reduced maximum output power (referred to as power management maximum power reduction, P-MPR) and reduced UL transmission duty cycle. For example, the UE capability field “maxUplinkDutyCycle-FR2” indicates the maximum percentage of symbols during 1s that can be scheduled for uplink transmission regulatory exposure limits. If the UE capability field “maxUplinkDutyCycle-FR2” is not present, or is present but the percentage of uplink symbols transmitted within any 1s evaluation period exceeds the indicated percentage, the UE can apply P-MPR to meet the regulatory exposure limits by reducing the maximum output power for the relevant UE power class with some dB value.

A drawback of these approaches is that the maximum uplink performance can be significantly deteriorated. By indicating maximum exposure constraints for each indicted reference signal resource, wherein the performance metric is specific for the antenna panel entity corresponding to the indicted reference signal resource, the wireless communication network may be made aware of potential variations of maximum exposure constraints among the antenna panel entity, and apply such knowledge to UL scheduling to improve uplink performance. For example, the wireless communication network may bias selection among the indicated reference signal resources towards reference signal resources with maximum exposure constraints corresponding to relatively high emission.

More generally, the wireless communication network may bias selection among the indicated reference signal resources towards reference signal resources with relatively high performance metric.

Generally, the performance metric may refer to any suitable performance metric. For example, the performance metric may be an UL performance (e.g., UL RSRP), or a DL performance combined with an UL compensation (e.g., DL RSRP plus UL power factor).

When the measurements have been performed and corresponding reports have been transmitted, the wireless communication network and the wireless communication device may perform communication accordingly. This is illustrated by optional steps 380 and 480.

For example, the wireless communication network may performing scheduling of simultaneous UL transmission from the wireless communication device to two or more radio access nodes, as illustrated by optional sub-step 490, wherein the scheduling is based on the first and second measurement reports, and on the acquired information regarding combinations of reference signal resources.

Information regarding the scheduling may be conveyed to the wireless communication device in any suitable way, including an explicit or implicit instruction to apply the same antenna panel entities (and/or the same spatial filter setting) for the UL transmission as was used for the measurements corresponding to the indicated reference signaling resources.

It should be noted that, for some executions of steps 360 and 370, the measurements in step 360 are performed for only one of the two or more groups of reference signal resources and the reporting in step 370 comprises only one measurement report relating to the corresponding radio access node.

For example, a trigger message received in step 340 from one of the radio access node may trigger measurements and reporting for only that radio access node, or for other radio access node(s) as well. Alternatively or additionally, autonomous determination in step 350 may trigger measurements and reporting for only that radio access node, or for several radio access node(s).

However, measurements are performed in step 360 for each of the involved (first and second) radio access nodes at some point in time during execution of the method 300, and corresponding reporting is performed in step 370 for each of the involved (first and second) radio access nodes at some point in time during execution of the method 300.

When step(s) of the method 400 is/are performed by a central processing node, the partition between the central processing node and the radio access nodes of wireless communication network actions is typically based on timing requirements associated with each action. For example, actions associated with relatively long-term requirements (i.e., where a relatively long time delay is acceptable) may be performed by either of the central processing node and a radio access node, while actions associated with relatively short-term requirements (i.e., where only a relatively short time delay is acceptable) should typically be performed by a radio access node.

To exemplify, handling of one or more of the capability message, the configuration message, and the report setting may be performed by the central processing node or by a radio access node. The activation message may be handled by the central processing node or a radio access node, while the trigger message is typically handled by a radio access node. The processing of information conveyed by the measurement reports (e.g., UL scheduling) may be handled by the central processing node or a radio access node.

Typically, all information exchange between the wireless communication device and the central processing node is implemented by signaling between the wireless communication device and one or more radio access node, combined with signaling between the one or more radio access node and the central processing node.

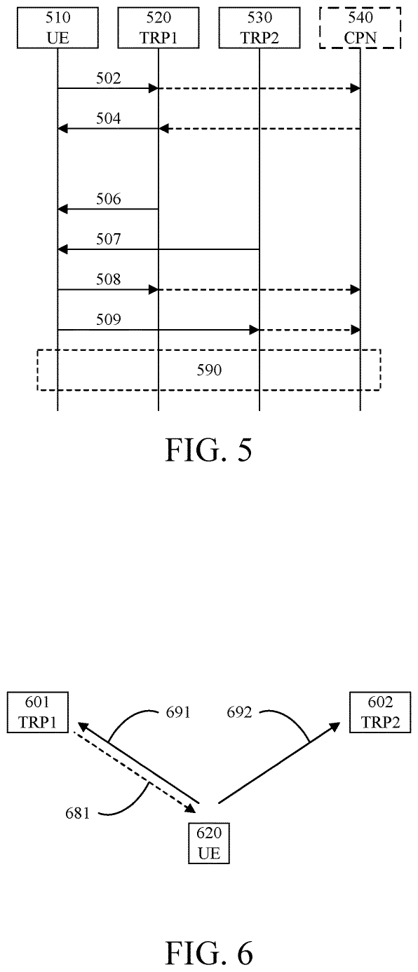

FIG. 5 illustrates example signaling between a wireless communication device (exemplified by the user equipment UE 510 in FIG. 5; compare with the UE 120 of FIG. 1 and the wireless communication device 200 of FIG. 2) and a wireless communication network. The wireless communication network comprises two or more radio access nodes (exemplified by the two transmission/reception points TRP1 520 and TRP2 530 in FIG. 5; compare with TRP 110 of FIG. 1). In some embodiments, the wireless communication network also comprises a central processing node (illustrated by optional central processing node CPN 540 in FIG. 5) configured to control operation of the wireless communication network.

For example, the UE 510 may be configured to perform at least some steps of the method 300 described in connection with FIG. 3. Alternatively or additionally, one or more of the TRP1 520, the TRP2 530, and the CPN 540 may be configured to perform at least some steps of the method 400 described in connection with FIG. 4.

The signaling of FIG. 5 commences in that the UE 510 transmits a capability message 502, which is received by the wireless communication network (compare with steps 310 and 410 of FIGS. 3 and 4).

The capability message may be received by one, some, or all of the involved radio access nodes. In some embodiments, the capability message (or information conveyed by the capability message) is forwarded to the central processing node by one or more of the radio access nodes, such that the capability message is received by the central processing node. This is exemplified in FIG. 5 in that TRP1 520 receives the capability message 502 and forwards it to the CPN 540.

The signaling of FIG. 5 continues in that the wireless communication network transmits a configuration message 504, which is received by the UE 510 (compare with steps 320 and 420 of FIGS. 3 and 4).

In the example of FIG. 5, the configuration message 504 may comprise a report setting (compare with steps 330 and 430 of FIGS. 3 and 4), and/or a trigger/activation message (compare with steps 340 and 440 of FIGS. 3 and 4).

The configuration message may be transmitted by one, some, or all of the involved radio access nodes. In some embodiments, the configuration message (or information to be conveyed by the configuration message) is received by one or more of the radio access nodes from the central processing node. This is exemplified in FIG. 5 in that TRP1 520 transmits the configuration message 504 based on information provided by the CPN 540.

The signaling of FIG. 5 continues in that each of the involved radio access nodes (i.e., TRP1 520 and TRP2 530) performs reference signal transmission 506, 507 in a respective group of reference signal resources, and the UE 510 performs measurements for the groups of reference signal resources (compare with steps 360 and 450 of FIGS. 3 and 4), wherein each measurement uses a respective antenna panel entity with a respective spatial filter setting.

The signaling of FIG. 5 continues in that the UE 510 transmits a measurement report 508, 509 for each group of reference signal resources, and the measurement reports are received by the wireless communication network (compare with steps 370 and 470 of FIGS. 3 and 4).

Each measurement report may be received by one, some, or all of the involved radio access nodes. In some embodiments, a measurement report (or information conveyed by the measurement report) is forwarded to the central processing node by one or more of the radio access nodes. This is exemplified in FIG. 5 in that TRP1 520 receives the measurement report 508 (which typically corresponds to measurements performed for the group of reference signal resources used by TRP1 520 during the reference signal transmission 506) and forwards it to the CPN 540, and in that TRP2 530 receives the measurement report 509 (which typically corresponds to measurements performed for the group of reference signal resources used by TRP2 530 during the reference signal transmission 507) and forwards it to the CPN 540.

The UE 510 also indicates to the wireless communication network which combinations of reference signal resources (as indicated by the measurement reports) correspond to combinations of antenna panel entities which are configurable for simultaneous transmission from the UE 510. In relation to the signaling of FIG. 5, such an indication may be conveyed by the capability message 502 and/or the measurement reports 508, 509. In some embodiments, the indication is derivable from a combination of the report setting and information conveyed by the capability message 502 and/or the measurement reports 508, 509.

When the measurements have been performed and corresponding reports have been transmitted, the wireless communication network and the UE 510 may perform communication accordingly, as illustrated by 590 (compare with steps 380 and 480 of FIGS. 3 and 4). For example, the CPN 540 may schedule simultaneous UL transmission (from the UE 510) to the TRP1 520 and the TRP2 530 (compare with step 490 of FIG. 4), and the UE 510 may perform the scheduled UL transmission.

It should be noted that features described in connection with FIG. 3 and/or FIG. 4 may be equally applicable in the context of FIG. 5, even if not explicitly mentioned in connection thereto.

FIG. 6 illustrates example signaling between a wireless communication device (exemplified by the user equipment UE 620 in FIG. 6; compare with the UE 120 of FIG. 1, the wireless communication device 200 of FIG. 2, and the UE 510 of FIG. 5) and two radio access nodes of a wireless communication network (exemplified by the two transmission/reception points TRP1 601 and TRP2 602 in FIG. 6; compare with TRP 110 of FIG. 1, and TRP1 520 and TRP2 530 of FIG. 5).

For example, the UE 620 may be configured to perform at least some steps of the method 300 described in connection with FIG. 3. Alternatively or additionally, one or more of the TRP1 601 and the TRP2 602 may be configured to perform at least some steps of the method 400 described in connection with FIG. 4.

FIG. 6 illustrates that the UE 620 transmits a one measurement report 691 to TRP1 601 and another measurement report 692 to TRP1 602. Each report 691, 692 typically corresponds to measurements performed for the group of reference signal resources used by TRP1 601 and TRP2 602, respectively, during the reference signal transmission. FIG. 6 also illustrates optional triggering/activation 681 of the reporting by TRP1 601.

According to one example, one TRP (here; TRP1 601) aperiodically triggers non-group-based reporting for multiple TRPs. The trigger message 681 may, for example, be conveyed via downlink control information (DCI). In some embodiments, the trigger message 681 triggers separate non-group-based beam reports 691, 692 to each of TRP1 601 and TRP2 602 (e.g., a single report for each of TRP1 601 and TRP2 602). In some embodiments, the trigger message 681 triggers a separate non-group-based beam report 691 to TRP1 601 (e.g., a single report for TRP1 601) and another trigger message (not shown) from TRP2 602 triggers a separate-but linked-non-group-based beam report 692 to TRP2 602 (e.g., a single report for TRP2 602). Thus, one trigger message may be conveyed by respective DCI from each of TRP1 601 and TRP2 602, where the trigger message from TRP1 triggers a first report setting (and corresponding first beam report of the non-group based beam reporting) and the trigger message from TRP2 triggers a second report setting (and corresponding second beam report of the non-group based beam reporting).

According to one example, one TRP (here; TRP1 601) semi-persistently activates non-group-based reporting for multiple TRPs. The activation message 681 may, for example, be conveyed via medium access control control element (MAC-CE). The activation message 681 activates separate non-group-based beam reports 691, 692 to each of TRP1 601 and TRP2 602. For example, the activation message 681 may cause several reports for each of TRP1 601 and TRP2 602.

According to one example, one UE 620 triggers non-group-based reporting for multiple TRPs, and transmits separate non-group-based beam reports 691, 692 to each of TRP1 601 and TRP2 602. For example, when a beam (or a spatial filter) corresponding to one of the TRPs (e.g., TRP1 601) changes, a non-group-based beam report 691 corresponding to that TRP (e.g., TRP1 601) may be triggered and transmitted by the UE 620 to that TRP (e.g., TRP1 601), while-typically-no non-group-based beam report transmission is triggered corresponding to other TRP(s) (e.g., TRP2 602).

For example, the non-group-based beam reports 691, 692 may be conveyed, respectively, via a first physical uplink control channel (PUCCH) in a first PUCCH resource to TRP1, and via a second PUCCH in a second PUCCH resource to TRP2. Alternatively, the non-group-based beam report 691 may be conveyed via a physical uplink shared channel (PUSCH) targeted to TRP1, and the non-group-based beam report 692 may be conveyed via a PUCCH in a PUCCH resource to TRP2. Yet alternatively, the non-group-based beam report 691 may be conveyed via a dynamically scheduled PUSCH targeted to TRP1, and the non-group-based beam report 692 may be conveyed via PUSCH with configured grant towards TRP2.

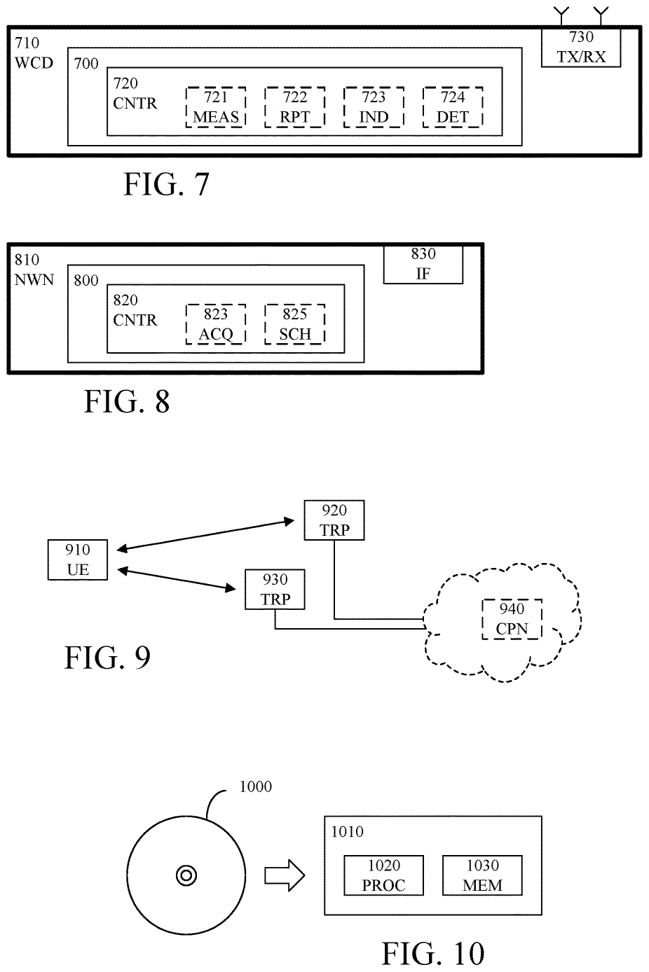

FIG. 7 schematically illustrates an example apparatus 700 according to some embodiments. The apparatus 700 comprises a controller (CNTR; e.g., controlling circuitry or a control module) 720.

The apparatus 700 is for (e.g., comprised, or comprisable, in) a wireless communication device WCD 710, which is configured for communication with a wireless communication network and has a plurality of antenna panel entities.

For example, the WCD 710 of FIG. 7 may correspond to one or more of the UE 120 of FIG. 1, the wireless communication device 200 of FIG. 2, the UE 510 of FIG. 5, and the UE 620 of FIG. 6. Alternatively or additionally, the WCD 710 of FIG. 7 may be configured to perform at least some steps of the method 300 described in connection with FIG. 3.

The controller 720 is configured to cause performance of measurements for first and second groups of reference signal resources, wherein each group of reference signal resources is associated with reference signal transmission from a respective-first and second-radio access node of the wireless communication network, and wherein each measurement uses a respective antenna panel entity with a respective spatial filter setting (compare with step 360 of FIG. 3).

To this end, the controller 720 may comprise, or be otherwise associated with (e.g., connected, or connectable, to), a measurer (MEAS; e.g., measuring circuitry or a measurement module) 721. The measurer 721 may be configured to perform the measurements for the first and second groups of reference signal resources, using a respective antenna panel entity with a respective spatial filter setting.

The controller 720 is also configured to cause transmission of first and second measurement reports, wherein each measurement report indicates one or more reference signal resource(s) from a corresponding one of the first and second groups of reference signal resources (compare with step 370 of FIG. 3).

To this end, the controller 720 may comprise, or be otherwise associated with (e.g., connected, or connectable, to), a reporter (RPT; e.g., reporting circuitry or a report module) 722. The reporter 722 may be configured to generate and transmit the measurement reports; e.g., via a transceiver (TX/RX) 730 of the WCD 710.

The controller 720 is also configured to cause indication, to the wireless communication network, of combinations of reference signal resources indicated by the first and second measurement reports that correspond to combinations of antenna panel entities which are configurable for simultaneous transmission from the wireless communication device (e.g., as part of the measurements reports, or as otherwise exemplified herein).

To this end, the controller 720 may comprise, or be otherwise associated with (e.g., connected, or connectable, to), an indicator (IND; e.g., indicating circuitry or an indication module) 723. The indicator 723 may be configured to indicate the combinations of reference signal resources; e.g., by transmission of the measurement reports via the transceiver 730.

The controller 720 may also be configured to cause transmission (e.g., via the transceiver 730) of a capability message to the wireless communication network, wherein the capability message indicates a capability of the wireless communication device to indicate antenna panel entity configurability for simultaneous transmission in association with measurement reporting comprising at least two measurements reports (compare with step 310 of FIG. 3).

Alternatively or additionally, the controller 720 may also be configured to cause reception (e.g., via the transceiver 730) of a configuration message from the wireless communication network, wherein the configuration message configures the wireless communication device to indicate antenna panel entity configurability for simultaneous transmission in association with measurement reporting comprising at least two measurements reports (compare with step 320 of FIG. 3).

Yet alternatively or additionally, the controller 720 may also be configured to cause reception (e.g., via the transceiver 730) of a report setting from the wireless communication network, wherein the report setting indicates a respective-first and second-setting for each of the first and second measurement reports, wherein the first setting indicates the first group of reference signal resources and the second setting indicates the second group of reference signal resources (compare with step 330 of FIG. 3).

Yet alternatively or additionally, the controller 720 may also be configured to cause reception (e.g., via the transceiver 730) of a trigger message from the wireless communication network, wherein reception of the trigger message causes measurements to be performed for at least one of the first and second groups of reference signal resources (compare with step 340 of FIG. 3).

Yet alternatively or additionally, the controller 720 may also be configured to cause reception (e.g., via the transceiver 730) of an activation message from the wireless communication network, wherein reception of the activation message causes measurements to be repeatedly performed for the first and second groups of reference signal resources (compare with step 340 of FIG. 3).

Yet alternatively or additionally, the controller 720 may also be configured to cause determination of whether a measurement condition is met, wherein determination that the measurement condition is met causes measurements to be performed for at least one of the first and second groups of reference signal resources (compare with step 350 of FIG. 3).

To this end, the controller 720 may comprise, or be otherwise associated with (e.g., connected, or connectable, to), a determiner (DET; e.g., determining circuitry or an determination module) 724. The determiner 724 may be configured to determine whether the measurement condition is met.

The controller 720 may also be configured to cause communication (e.g., via the transceiver 730) with the wireless communication network when the measurements have been performed and corresponding reports have been transmitted (compare with step 380 of FIG. 3).

FIG. 8 schematically illustrates an example apparatus 800 according to some embodiments. The apparatus 800 comprises a controller (CNTR; e.g., controlling circuitry or a control module) 820.

The apparatus 800 is for (e.g., comprised, or comprisable, in) a network node NWN 810 relating to a wireless communication network configured for communication with a wireless communication device having a plurality of antenna panel entities. The NWN 810 may be a radio access node (e.g., a TRP) of the wireless communication network, or a central processing node configured to control operation of the wireless communication network (e.g., a network control node, a cloud server node, or similar).

For example, the NWN 810 of FIG. 8 may correspond to one or more of the TRP 110 of FIG. 1, the TRP1 520 of FIG. 5, the TRP2 530 of FIG. 5, the CPN 540 of FIG. 5, the TRP1 601 of FIG. 6, and the TRP2 602 of FIG. 6. Alternatively or additionally, the NWN 810 of FIG. 8 may be configured to perform at least some steps of the method 400 described in connection with FIG. 4.

The controller 820 is configured to cause the wireless communication device to perform measurements for first and second groups of reference signal resources, wherein each group of reference signal resources is associated with reference signal transmission from a respective-first and second-radio access node of the wireless communication network, and wherein each measurement uses a respective antenna panel entity with a respective spatial filter setting (compare with step 460 of FIG. 4).

For example, the controller 820 may be configured to cause the wireless communication device to perform measurements by causing transmission (e.g., via an interface IF 830 of the NWN 810) of one or more of: a configuration message (compare with step 420 of FIG. 4), a report setting (compare with step 430 of FIG. 4), a trigger/activation message (compare with step 440 of FIG. 4), and reference signaling a (compare with step 450 of FIG. 4). When the NWN 810 is a radio access node, the interface 830 is typically a transceiver for direct communication with the wireless communication device, and when the NWN 810 is a central processing node, the interface 830 is for communication with the wireless communication device via a radio access node.

The controller 820 is also configured to cause reception (e.g., via a transceiver of a radio access node) of first and second measurement reports, wherein each measurement report indicates one or more reference signal resource(s) from a corresponding one of the first and second groups of reference signal resources (compare with step 470 of FIG. 4).

The controller 820 is also configured to cause acquisition, from the wireless communication device, of information regarding combinations of reference signal resources indicated by the first and second measurement reports that correspond to combinations of antenna panel entities which are configurable for simultaneous transmission from the wireless communication device (e.g., as part of the measurements reports, or as otherwise exemplified herein).

To this end, the controller 820 may comprise, or be otherwise associated with (e.g., connected, or connectable, to), an acquirer (ACQ; e.g., acquiring circuitry or an acquisition module) 823. The acquirer 823 may be configured to acquire the information regarding combinations of reference signal resources; e.g., by reception of the measurement reports via the interface 830.

The controller 820 may also be configured to cause reception (e.g., via the interface 830) of a capability message from the wireless communication network, wherein the capability message indicates a capability of the wireless communication device to indicate antenna panel entity configurability for simultaneous transmission in association with measurement reporting comprising at least two measurements reports (compare with step 410 of FIG. 4).

The controller 820 may also be configured to cause communication (e.g., via a transceiver of a radio access node) with the wireless communication device when the measurement reports have been received (compare with step 480 of FIG. 4).

For example, the controller 820 may also be configured to cause scheduling of simultaneous transmission from the wireless communication device based on the first and second measurement reports, and on the acquired information regarding combinations of reference signal resources.

To this end, the controller 820 may comprise, or be otherwise associated with (e.g., connected, or connectable, to), a scheduler (SCH; e.g., scheduling circuitry or a scheduling module) 825. The scheduler 825 may be configured to perform the scheduling of simultaneous transmission from the wireless communication device.

Figure schematically illustrates an example communication system according to some embodiments. The communication system comprises a wireless communication device in the form of a UE 910, two radio access nodes in the form of two TRPs 920, 930, and (optionally) a central processing node CPN 940 (exemplified in FIG. 9 as comprised in a cloud structure).

The UE 910 of FIG. 9 may, for example, correspond to one or more of the UE 120 of FIG. 1, the wireless communication device 200 of FIG. 2, the UE 510 of FIG. 5, the UE 620 of FIG. 6, and the WCD 710 of FIG. 7. Alternatively or additionally, the UE 910 of FIG. 9 may be configured to perform at least some steps of the method 300 described in connection with FIG. 3.

Each of the TRPs 920, 930 of FIG. 9 may, for example, correspond to one or more of the TRP 110 of FIG. 1, the TRP1 520 of FIG. 5, the TRP2 530 of FIG. 5, the TRP1 601 of FIG. 6, the TRP2 602 of FIG. 6, and the NWN 810 of FIG. 8. Alternatively or additionally, each of the TRPs 920, 930 of FIG. 9 may be configured to perform at least some steps of the method 400 described in connection with FIG. 4.

The CPN 940 of FIG. 9 may, for example, correspond to one or more of the CPN 540 of FIG. 5, and the NWN 810 of FIG. 8. Alternatively or additionally, CPN 940 of FIG. 9 may be configured to perform at least some steps of the method 400 described in connection with FIG. 4.

To summarize, according to some embodiments a UE is configured with a (e.g., CSI) reporting configuration for non-group-based beam reporting in relation to simultaneous UL multi-panel transmission (compare—for example—with 320 and/or 330 of FIG. 3), based on which the UE performs measurements (compare—for example—with 360 of FIG. 3) on two groups of reference signals and transmits two separate beam reports (compare—for example—with 370 of FIG. 3), where each beam report is facilitating simultaneous multi-panel UL transmissions (e.g., based on the use of multi-DCI).

It should be noted that the term “non-group-based beam reporting” (which has been used in discussions related to NR standardization) is not to be considered as limiting. Contrarily, the term “non-group-based beam reporting” relates to any reporting (e.g., as specified for 3GPP; 5G advanced or 6G) where a wireless communication device with two or more antenna panel entities transmits a beam report per radio access node for a scenario where the wireless communication device communicates with two or more radio access nodes (e.g., multi-TRP or D-MIMO), and where the beam reports are associated with each other to enable the wireless communication network to determine whether a beam indicated in one report for a first radio access node can be used for simultaneous UL transmission together with a beam indicated in another report for a second radio access node.

It should also be noted that the term “beam” may represent uplink spatial filtering coefficients/configuration and/or downlink spatial filtering coefficients/configuration according to 3GPP specifications. The reference signals may, for example, be CSI-RS (in which case the UE reports a CSI-RS resource index, CRI, e.g., in step 370 of FIG. 3) or SSB (in which case the UE reports a SSB resource index, SSBRI, e.g., in step 370 of FIG. 3).

Generally, features described in connection with one embodiment herein may be equally applicable (as suitable and mutatis mutandis) in the context of another embodiment, even if not explicitly mentioned in connection thereto.

Also generally, it should be noted that the approaches, features, and advantages described herein may be generally applicable for any situation that handles simultaneous transmission from a wireless communication device that has a plurality of antenna panel entities to two or more radio access nodes of the wireless communication network, even though exemplification herein relates to multi-TPR. For example, the wireless communication network may be a distributed multiple-input multiple-output (D-MIMO) system, wherein the radio access nodes are D-MIMO access points (APs) and the central processing node is a D-MIMO control unit (CU; a.k.a., a D-MIMO central processing unit, CPU).

The described embodiments and their equivalents may be realized in software or hardware or a combination thereof. The embodiments may be performed by general purpose circuitry. Examples of general purpose circuitry include digital signal processors (DSP), central processing units (CPU), co-processor units, field programmable gate arrays (FPGA) and other programmable hardware. Alternatively or additionally, the embodiments may be performed by specialized circuitry, such as application specific integrated circuits (ASIC). The general purpose circuitry and/or the specialized circuitry may, for example, be associated with or comprised in an apparatus such as a wireless communication device, a radio access node, or a central processing node.

Embodiments may appear within an electronic apparatus (such as a wireless communication device, a radio access node, or a central processing node) comprising arrangements, circuitry, and/or logic according to any of the embodiments described herein. Alternatively or additionally, an electronic apparatus (such as a wireless communication device, a radio access node, or a central processing node) may be configured to perform methods according to any of the embodiments described herein.

According to some embodiments, a computer program product comprises a non-transitory computer readable medium such as, for example, a universal serial bus (USB) memory, a plug-in card, an embedded drive, or a read only memory (ROM). FIG. 10 illustrates an example computer readable medium in the form of a compact disc (CD) ROM 1000. The computer readable medium has stored thereon a computer program comprising program instructions. The computer program is loadable into a data processor (PROC; e.g., a data processing unit) 1020, which may, for example, be comprised in an electronic apparatus 1010 (such as a wireless communication device, a radio access node, or a central processing node). When loaded into the data processor, the computer program may be stored in a memory (MEM) 1030 associated with, or comprised in, the data processor. According to some embodiments, the computer program may, when loaded into, and run by, the data processor, cause execution of method steps according to, for example, any of the methods illustrated in FIGS. 3 and 4, or otherwise described herein.

Generally, all terms used herein are to be interpreted according to their ordinary meaning in the relevant technical field, unless a different meaning is clearly given and/or is implied from the context in which it is used.

Reference has been made herein to various embodiments. However, a person skilled in the art would recognize numerous variations to the described embodiments that would still fall within the scope of the claims.

For example, the method embodiments described herein discloses example methods through steps being performed in a certain order. However, it is recognized that these sequences of events may take place in another order without departing from the scope of the claims. Furthermore, some method steps may be performed in parallel even though they have been described as being performed in sequence. Thus, the steps of any methods disclosed herein do not have to be performed in the exact order disclosed, unless a step is explicitly described as following or preceding another step and/or where it is implicit that a step must follow or precede another step.

In the same manner, it should be noted that in the description of embodiments, the partition of functional blocks into particular units is by no means intended as limiting. Contrarily, these partitions are merely examples. Functional blocks described herein as one unit may be split into two or more units. Furthermore, functional blocks described herein as being implemented as two or more units may be merged into fewer (e.g. a single) unit.

Any feature of any of the embodiments disclosed herein may be applied to any other embodiment, wherever suitable. Likewise, any advantage of any of the embodiments may apply to any other embodiments, and vice versa.

Hence, it should be understood that the details of the described embodiments are merely examples brought forward for illustrative purposes, and that all variations that fall within the scope of the claims are intended to be embraced therein.

1. A method for a wireless communication device configured for communication with a wireless communication network and having a plurality of antenna panel entities, the method comprising:
performing measurements for first and second groups of reference signal resources, wherein each group of reference signal resources is associated with reference signal transmission from a respective-first and second-radio access node of the wireless communication network, and wherein each measurement uses a respective antenna panel entity with a respective spatial filter setting;
transmitting first and second measurement reports, wherein each measurement report indicates one or more reference signal resource(s) from a corresponding one of the first and second groups of reference signal resources; and
indicating, to the wireless communication network, combinations of reference signal resources indicated by the first and second measurement reports that correspond to combinations of antenna panel entities which are configurable for simultaneous transmission from the wireless communication device.

2. The method of claim 1, wherein each antenna panel entity of the plurality of antenna panel entities comprises one or more of: a physical antenna panel, a virtual antenna panel, and a logical antenna panel.

3. The method of claim 1, further comprising transmitting a capability message to the wireless communication network, wherein the capability message indicates a capability of the wireless communication device to indicate antenna panel entity configurability for simultaneous transmission in association with measurement reporting comprising at least two measurements reports.

4. The method of claim 3, wherein the capability message comprises information regarding which combinations of antenna panel entities among the plurality of antenna panel entities are configurable for simultaneous transmission from the wireless communication device.

5. The method of claim 4, wherein each measurement report further identifies a corresponding antenna panel entity for each indicated reference signaling resource.

6. The method of claim 1, further comprising receiving a report setting from the wireless communication network, wherein the report setting indicates a respective-first and second-setting for each of the first and second measurement reports, wherein the first setting indicates the first group of reference signal resources and the second setting indicates the second group of reference signal resources.

7. The method of claim 6, wherein the report setting further indicates, for each reference signal resource of a group of reference signal resources, the spatial filter setting to be used for performing corresponding measurement.

8. The method of claim 6, wherein the report setting further indicates that all antenna panel entities used to perform measurements for the first group of reference signal resources are to be configurable for simultaneous transmission from the wireless communication device with all antenna panel entities used to perform measurements for the second group of reference signal resources.

9. The method of claim 1, wherein at least one of the first and second measurement reports comprises, for each indicated reference signal resource, identification of reference signal resources for simultaneous transmission among reference signal resources indicated by the other-first or second-measurement report.

10. The method of claim 1, wherein at least one of the first and second measurement reports comprises information that any reference signal resource indicated by the first measurement report is for simultaneous transmission with any reference signal resources indicated by the second measurement report.

11. The method of claim 1, further comprising receiving a configuration message from the wireless communication network, wherein the configuration message configures the wireless communication device to indicate antenna panel entity configurability for simultaneous transmission in association with measurement reporting comprising at least two measurements reports.

12. The method of claim 1, further comprising receiving a trigger message from the wireless communication network, wherein reception of the trigger message causes measurements to be performed for at least one of the first and second groups of reference signal resources.

13. The method of claim 1, further comprising receiving an activation message from the wireless communication network, wherein reception of the activation message causes measurements to be repeatedly performed for the first and second groups of reference signal resources.

14. The method of claim 1, further comprising determining whether a measurement condition is met, wherein determination that the measurement condition is met causes measurements to be performed for at least one of the first and second groups of reference signal resources.

15. The method of claim 1, wherein each measurement report indicates a performance metric for each indicted reference signal resource, wherein the performance metric is specific for the antenna panel entity corresponding to the indicted reference signal resource.

16. The method of claim 15, wherein the performance metric for an antenna panel entity is based on maximum exposure constraints of the antenna panel entity.

17. A method for a wireless communication network configured for communication with a wireless communication device having a plurality of antenna panel entities, the method comprising:
causing the wireless communication device to perform measurements for first and second groups of reference signal resources, wherein each group of reference signal resources is associated with reference signal transmission from a respective-first and second-radio access node of the wireless communication network, and wherein each measurement uses a respective antenna panel entity with a respective spatial filter setting;
receiving first and second measurement reports, wherein each measurement report indicates one or more reference signal resource(s) from a corresponding one of the first and second groups of reference signal resources; and
acquiring, from the wireless communication device, information regarding combinations of reference signal resources indicated by the first and second measurement reports that correspond to combinations of antenna panel entities which are configurable for simultaneous transmission from the wireless communication device.

18. The method of claim 17, wherein each antenna panel entity of the plurality of antenna panel entities comprises one or more of: a physical antenna panel, a virtual antenna panel, and a logical antenna panel.

19. The method of claim 17, further comprising receiving a capability message from the wireless communication device, wherein the capability message indicates a capability of the wireless communication device to indicate antenna panel entity configurability for simultaneous transmission in association with measurement reporting comprising at least two measurements reports.

20. The method of claim 19, wherein the capability message comprises information regarding which combinations of antenna panel entities among the plurality of antenna panel entities are configurable for simultaneous transmission from the wireless communication device.

21.-68. (canceled)
